(19) United States
(12) Patent Application Publication
(10) Pub. No.: US 2026/0090543 A1
(43) Pub. Date: Apr. 2, 2026

(54) ADDUCT MATERIAL USEFUL FOR PLANT GROWTH PROMOTION

(71) Applicant: NanoGraphene Fertilizer, Inc., Santa Fe Springs, CA (US)

(72) Inventors: Jong Wan Yoo, Suwon-si (KR); Jeong Kook Suh, Anaheim, CA (US); Rib Kim, Suwon-si (KR); Heon Sang Kim, Seoul (KR); Song Yeon Kim, Jecheon-si (KR)

(73) Assignee: NanoGraphene Fertilizer, Inc., Santa Fe Springs, CA (US)

(21) Appl. No.: 18/904,029

(22) Filed: Oct. 1, 2024

(51) Int. Cl. A01N 37/36; A01N 25/12; A01P 21/00

(52) U.S. Cl. CPC A01N 37/36; A01N 25/12; A01P 21/00

(57) ABSTRACT

The present invention relates to a water-soluble adduct material for promoting plant growth, in which the material may be obtained by heating and reacting graphene, glycerol and citric acid. The material according to the present invention serves as an active ingredient for promoting the germination and growth of plants while being incorporated in soil or absorbed in a plant body, and may be further provided to improve a long-term growth environment of crops in farmland in a dry climate zone.

### BACKGROUND OF THE INVENTION

### Field of the Invention

The present invention relates to a material for promoting plant growth, in which the material may be obtained by reacting graphene, glycerol and citric acid. The material according to the present invention serves as an active ingredient for promoting the germination and growth of plants while being incorporated in soil or absorbed in a plant body, and may be further provided to improve a growth environment of crops in farmland in a dry climate zone.

### Description of the Prior Art

Recently, a demand for agricultural products has rapidly increased due to an increase in the global population and a preference for high-quality food, but an environment for cultivating crops is deteriorating due to a spread of environmental pollution and global warming. Accordingly, the use of chemical fertilizers and pesticides is gradually increasing, and it is also a well-known fact that the use causes acidification of farmland and excessive accumulation of salts in the soil, thus resulting in the devastation of farmland.

In order to overcome this problem, improvement of crop seeds, an organic farming method of using compost, application of fertilizers containing components which emit far-infrared light, application of fertilizers containing a small amount of mineral components, supply of soil microbes, and the like have been suggested.

However, despite these efforts, the use of these substances as an alternative to the use of chemical fertilizers also has problems similar to the side effects caused by the application of chemical fertilizers.

As another alternative, a method of using a composition containing nano-sized particles has recently been proposed (Unexamined Patent Publication No. 10-2017-0067440). Specifically, the use of nanoparticles containing a metal component such as iron, calcium or magnesium, or a metal oxide component may be considered.

In addition, the use of fertilizer compositions containing nanoparticles containing carbon as a main component has also been reported. As one example, according to International Unexamined Patent Publication No. WO 2015/066691, graphene, which is a nanoparticle having carbon as a main component, may be used. Accordingly, described is a method for improving an effect of using fertilizer by using a fertilizer composition in the form of surrounding the surface of conventional chemical fertilizer such as potassium nitrate with graphene, thereby slowly discharging ingredients of chemical fertilizer from the surface thereof. However, the above report does not make a mention about an effect of the graphene material per se acting as an active ingredient for promoting the germination and growth of plants. In other words, the above report describes only an effect of graphene on controlling a release rate of chemical fertilizer components into the soil.

Data reporting that graphene may be used as a plant growth promoter include Korean Unexamined Patent Application No. 10-2019-0023189, but a method of increasing a crop yield in farmland belonging to a dry climate zone using the same has not been reported yet.

### RELATED ART REFERENCES

### Patent Documents

(Patent Document 1) KR 10-2017-0067440 A (2017 Jun. 16)
(Patent Document 2) WO 2015/066691 A (2015 May 7)

### SUMMARY OF THE INVENTION

Considering the above-described problems, an object of the present invention is to provide a novel material capable of promoting the growth of trees while minimizing side effects caused by an excessive use of conventional chemical fertilizers, and in particular, increasing a production of crops in dry farmland.

To accomplish the above object, the present inventors dispersed graphene in glycerol and heated the same with citric acid. As a result, an adduct material in which graphene, glycerol and citric acid were chemically bonded was synthesized.

While the material was incorporated into the soil around plants or sprayed on a side surface thereof as a solution diluted in water, the promoted germination and growth of plants and a change in crop yield thereof were observed accordingly. As a result, it was confirmed that the material acts as a major active ingredient for promoting the germination and growth of the plants while being incorporated in the soil or absorbed in the plants, and it was also confirmed that the growth of crops is possible while the use of agricultural water is significantly reduced.

Accordingly, the present invention is intended to provide an active ingredient for promoting the growth of crops cultivated on dry farmland, which is characterized by an adduct material obtained by reacting graphene, glycerol and citric acid.

Here, it may be preferable that the graphene has an average thickness of 1 to 10 atomic layers with an average lateral size of 0.02 to 1.0 μm.

As a result of spraying the composition prepared according to the present invention onto a side surface of various plants including herbaceous plants and woody plants or spraying the same into the soil in the state of an aqueous solution diluted in water or by adsorbing the composition in talc powder, it was confirmed that germination of shoots of plant leaves is promoted and growth of leaves or stems is significantly enhanced. In addition, it was confirmed that the composition applied to plants and soil around the plants according to the present invention can serve in such a way that the plants are germinated and grown even in a soil environment of a dry climate zone where agricultural water is not smoothly supplied.

### BRIEF DESCRIPTION OF THE DRAWINGS

FIG. 1 is an image of a corn field in which Example 3 is implemented.

FIG. 2 is an image of a corn field in which Comparative Example is implemented.

### DETAILED DESCRIPTION OF THE EXEMPLARY EMBODIMENTS

The present invention may provide an adduct material obtained by reacting graphene, glycerol and citric acid as a material capable of serving as an active ingredient for promoting plant growth in the soil of a dry area.

The graphene may include graphene prepared by a CVD method or a physical exfoliation method, graphene oxide (GO) prepared by a chemical exfoliation method, and reduced graphene oxide (rGO) prepared by reducing the graphene oxide.

Hereinafter, the present invention will be described in detail.

Examples of the graphene which may be used in the present invention may include graphene and graphene oxide prepared in a top-down manner by mechanically or chemically exfoliating graphite, or reduced graphene oxide obtained by reducing the graphene oxide. In addition, another example of the graphene which may be used in the present invention may include graphene prepared in a bottom-up manner by chemical vapor deposition using a material containing carbon such as graphite or a hydrocarbon compound as a raw material.

In general, graphene or graphene oxide obtained in a top-down manner may mainly have a chemical structure having a carbon multi-layer, and graphene obtained in the bottom-up manner may mainly have a chemical structure close to a carbon single layer. When leaving aside a special process of synthesizing large-area graphene, a lateral size of the graphene obtained by the above two methods may be variously distributed from several tens of nm to several tens of μm, in general.

In addition, it is a well-known fact that ultrasonic treatment or ball-milling treatment after dispersing the graphene raw material in a dispersion solvent, and a subsequent classification process may be used to reduce an average thickness (expressed as the number of carbon layers) and an average lateral size of the graphene synthesized by the above method.

The graphene, which is preferable as an active ingredient for promoting plant growth, may have an average thickness of one to ten carbon layers and an average lateral size of 0.02 to 1.0 μm. When the average thickness of graphene is ten carbon layers or more, or when the average lateral size thereof is 1.0 μm or more, it may be hardly absorbed into plants. In addition, when preparing graphene with an average lateral size of 0.02 μm or less, economic feasibility may be problematic according to additional processes such as a classification process.

The graphene may be mixed with glycerol and citric acid and stirred at a temperature of 70 to 150° C. for one to three hours so as to obtain an adduct having a graphene content of 0.1 to 10 wt %. When the adduct according to the present invention is diluted in water and sprayed onto the soil, the adduct may be adsorbed on the soil particles of a topsoil layer, thereby effectively reducing evaporation of soil water to the atmosphere.

In addition, an aqueous solution of the adduct may be sprayed onto the soil after plants are planted, or the adduct may be sprayed onto the soil while being adsorbed on silicate-based mineral particles such as talc. In this case, it may be preferable that the amount of adduct supplied to 1 are (100 square meters) of soil is adjusted within a range of 0.1 to 10 g based on one application. It may be natural that after one application, the adduct may be further applied at intervals of 10 to 30 days depending on the growth state of plants.

As another method, when graphene is applied to expensive plants, such as rare shrubs or trees, the adduct may be applied to soil around a main stem leading to the roots of individual trees, or an aqueous solution of the adduct may be supplied to trees through an irrigation injection. In this case, it may be preferable that a preferred amount of graphene to be supplied per 100 parts by weight of trees is adjusted to 0.1 to 10.0 parts by weight based on a fresh weight of trees. However, in the case of particularly expensive trees, an economic burden caused by applying graphene may be relatively reduced, and thus it may be natural that an amount of the adduct to be supplied per 100 parts by weight of trees is adjusted to 10.0 parts by weight or more.

The adduct may also be provided to crops or trees through a side surface application while being diluted in water. In this case, it may be preferable that a concentration of an aqueous solution of the adduct diluted therein is adjusted to 10 to 1000 ppm (weight/volume), and it may be preferable that an amount of the adduct to be applied is adjusted within a range of 0.1 to 10 g based on 1 are of the soil in which plants are planted. It may be natural that after one application, the adduct may be further applied at intervals of 10 to 30 days depending on the growth state of plants.

In the present invention, the adduct containing graphene may contribute as an active ingredient, either directly or indirectly, to the promotion of plant growth in two different environments such as in soil and within a plant as follows.

First, a graphene component included in the adduct may contribute to the growth of plants while being adsorbed onto a soil surface, and thus the emission of far-infrared rays from the soil may be increased due to graphene, and furthermore, a nanosurface effect of graphene may act on a migration process of moisture and nutrients occurring at an interface between soil and plant roots, thereby helping the growth of plants (for example, in a manner in which nutrients of organic or inorganic components are adsorbed onto a graphene surface and easily transferred to roots).

Second, graphene may contribute to the promotion of plant growth under an environment in which graphene is present in plants. Graphene applied to promote plant growth may be absorbed into a plant body from a root or side surface while being dispersed in water in a nano size. The planar graphene may have an average size in a dynamic equilibrium state as a shape that is three-dimensionally crumpled by Brownian motion in a solution, and a three-dimensional average diameter thereof may be much smaller than a lateral size of original graphene, and thus may be easily absorbed through the surface of roots, stems, or leaves of plants. Of course, it may be obvious that the smaller an original lateral size of the graphene provided to the soil or plant fertilization, the smaller a dynamic three-dimensional size of three-dimensional particles shown in a folded state, and thus an absorption speed and absorption rate thereof into the plant body may increase.

Apart from the action of graphene present in the soil environment, a specific mechanism of action in which graphene present in the plant body functions as an active ingredient for promoting the growth of plants has not been published to date. The present inventors intend to interpret the mechanism of action of graphene as an active ingredient for promoting plant growth from several theoretical viewpoints as follows.
First, a far-infrared effect may be considered. Since graphene forms a strong absorption band in the ultraviolet and far-infrared regions, graphene present in the plant body, that is, in leaves, stems or roots may increase an energy density of far-infrared rays in the plant body in such a manner as vibratory relaxation after ultraviolet absorption, resonant light scattering in the far-infrared region, and the like. In other words, when a far-infrared ray density is increased by the graphene in the plant body, it may be expected that a degree of activity of body fluid and the activity of enzymatic actions in the plant body are increased to help the growth of plants.
Second, a nanofluid effect of the graphene solution and an adsorption effect of graphene may be considered. When the graphene is dispersed in the body fluid of plants in a nano size, the nanofluidic effect and the adsorption ability of the graphene may serve to boost the movement of moisture and nutrients in the plant body through a water pipe, a body pipe, or other cell-to-cell movement channels in the plant body, thereby contributing to the growth of plants.
Third, an ultraviolet absorption effect of graphene may be considered. Specifically, since the activity of compounds constituting chlorophyll in plants may be reduced by an active oxygen, graphene in the plant body may effectively block ultraviolet rays to reduce the production of active oxygen species generated by ultraviolet rays, thereby preventing the reduction of chlorophyll activity and consequently enhancing photosynthesis of plants.
Fourth, graphene may contribute to a metabolic process of plants through a kind of auxiliary enzymatic role. For example, although the electrical and electronic behavior properties of graphene in vivo have not been sufficiently studied yet, we cannot exclude the possibility that graphene in the plant body may promote the growth of plants in such a way that the graphene is involved in the light and dark reactions of photosynthesis in plants, and an electron transfer process or proton transfer process essential for cell respiration.
Fifth, it may contribute to promoting metabolism of symbiotic microorganisms present in plant roots, stems, leaves and therearound through a mechanism of action of biochemical reactions such as the far-infrared effect of graphene, etc., as described above. As a direct or indirect result of the active metabolism of microorganisms symbiotic to plants, it may be estimated that the application of graphene according to the present invention may be another cause of facilitating the growth of plants.

In addition, the active material according to the present invention, that is, the adduct material obtained by reacting graphene, glycerol and citric acid may be coated on the soil particles. In other words, the adduct material may act as a water-soluble, high-viscosity material in a dry state and may be adsorbed on the surface of the soil particles in the farmland, thereby preventing evaporation of soil water.

Hereinafter, the present invention will be described in more detail through Examples, but the present invention is not limited thereto.

### Example 1: Preparation of “Graphene Aqueous Solution”

300 g of graphene powder purchased from NanoReader Co., Ltd. was added to 2700 g of purified water, and then subjected to ultrasonic waves for six hours while being mechanically stirred to prepare a “graphene aqueous solution” having a solid content of 10.0 wt %.

The “graphene aqueous solution” was sufficiently diluted in purified water to reach a nanodispersed state, and then a sample for measurement was prepared, and as a result of analyzing the sample with a transmission electron microscope (TEM) having a resolution of 2 nm, it was confirmed that the lateral size of graphene is distributed in the range of 20 to 1000 nm. In addition, as a result of analyzing the sample with an atomic force microscope (AFM), it was confirmed that the planar thickness of graphene is distributed in the range of 1 to 10 atomic layers.

### Example 2: Synthetic Reaction of “Adduct Material Containing Graphene”

The graphene aqueous solution obtained in Example 1 was dried at room temperature to obtain 300 g of graphene powder. 100 g of the powder was added to 4950 g of glycerol, and then subjected to ultrasonic waves for one hour to sufficiently disperse graphene particles. Subsequently, 4950 g of citric acid was added to the resulting mixture and stirred and reacted at a temperature of 100° C. for three hours to obtain an adduct. The resulting adduct is a very sticky substance at room temperature, and it may be preferable to add twice the amount of purified water to the adduct and store the same.

### Example 3: Application of “Adduct Material Containing Graphene” in Corn Field

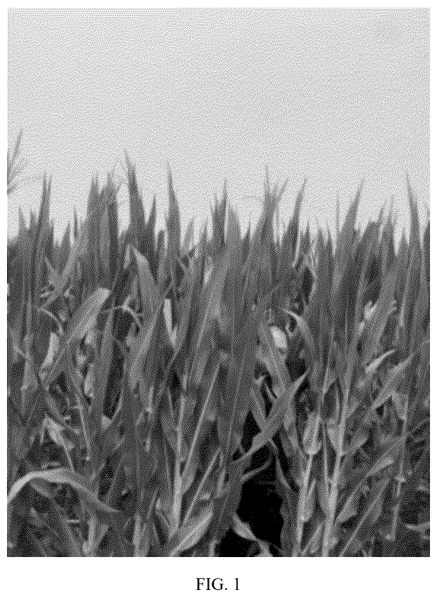

The “adduct” was diluted in agricultural water and sprayed into a corn field as an aqueous solution of 20 ppm (weight/volume) based on a graphene content. The selected corn field was a farmland located in Shandong Province, China, a region with relatively little precipitation. The date of spraying the adduct solution onto the corn field fell on Mar. 30, 2024, and the date of planting corn seeds fell on May 15, 2024. FIG. 1 is a picture of the corn field taken on Jul. 3, 2024. In this experiment, with respect to the amount of the adduct containing graphene to be applied, 20 liters of the diluted solution was used per 1 are of corn field area, and the amount of graphene used per 1 are of farmland area reached 0.4 g.

### Comparative Example: Comparative Example in Corn Field

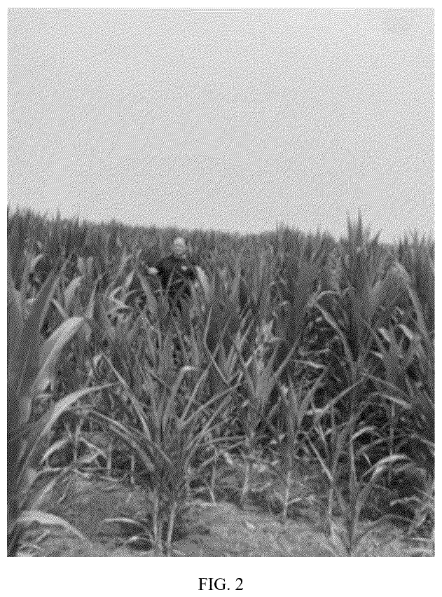

Corn was grown in the same manner as in the farmland located near the corn field in Example 3, but 20 liters of agricultural water without using the “adduct” was sprayed per 1 are to obtain a comparative example. FIG. 2 is a picture of corn field taken on Jul. 3, 2024, in which the comparative example was implemented.

### Analysis of Result of Application of Above “Adduct” in Corn Field

Comparing FIG. 1 and FIG. 2, it can be seen that the size and homogeneity of corn crops in the farmland of Example 3 treated with the adduct are remarkably superior to those of the farmland of Comparative Example.

1. A composition comprising:
an adduct material of graphene;
glycerol; and
citric acid as an active ingredient for promoting plant growth.

2. The composition of claim 1, wherein the graphene has an average thickness of 1 to 10 carbon atomic layers with an average lateral size of 0.02 to 1.0 μm.

3. The composition of claim 1, wherein raw materials for synthesizing the adduct material include 1.0 parts by weight of graphene, 10.0 to 100 parts by weight of glycerol, and 10.0 to 100 parts by weight of citric acid.
